(19) United States
(12) Patent Application Publication
(10) Pub. No.: US 2014/0075570 A1
(43) Pub. Date: Mar. 13, 2014

(54) METHOD, ELECTRONIC DEVICE, AND MACHINE READABLE STORAGE MEDIUM FOR PROTECTING INFORMATION SECURITY

(71) Applicants: Chao-Ling Hsu, Hsinchu City (TW); Yiou-Wen Cheng, Hsinchu City (TW); Liang-Che Sun, Taipei (TW); Jyh-Horng Lin, Hsinchu City (TW)

(72) Inventors: Chao-Ling Hsu, Hsinchu City (TW); Yiou-Wen Cheng, Hsinchu City (TW); Liang-Che Sun, Taipei (TW); Jyh-Horng Lin, Hsinchu City (TW)

(21) Appl. No.: 13/612,866

(22) Filed: Sep. 13, 2012

(51) Int. Cl. G06F 21/24

(52) U.S. Cl. 726/28

(57) ABSTRACT

An embodiment of the invention provides an electronic device. The electronic device is configured to protect a set of private data of an authorized user of the electronic device. The electronic device includes a biometric sampler, a biometric authenticator, and a data provider. The biometric sampler is configured to covertly collect a set of biometric samples from a current user of the electronic device. The biometric authenticator is configured to covertly use the set of biometric samples of the current user and a set of biometric data of the authorized user to verify whether the current user is the authorized user. The data provider is configured to give the current user access to a set of fake data instead of the set of private data if the current user is not the authorized user.

### BACKGROUND

1. Technical Field

The invention relates generally to information security, and more particularly, to a method for protecting information security.

2. Related Art

An electronic device may implement an authentication system to block unauthorized access. For example, the authentication system may explicitly request a person trying to use the device to first provide information for authentication. The information may be a password or a set of biometric samples. After the person provides the password or the set of biometric samples knowingly and voluntarily, the electronic device may verify the person's identity and decide whether to grant access.

However, if the person is an intended hacker/imposter, the explicit request may alert the person to the existence of the authentication system. In response, the person may become more prepared and try harder to crack the authentication system. In other words, an explicit authentication request sometimes may lead to undesirable results.

### SUMMARY

An embodiment of the invention provides an electronic device. The electronic device is configured to protect a set of private data of an authorized user of the electronic device. The electronic device includes a biometric sampler, a biometric authenticator, and a data provider. The biometric sampler is configured to covertly collect a set of biometric samples from a current user of the electronic device. The biometric authenticator is configured to covertly use the set of biometric samples of the current user and a set of biometric data of the authorized user to verify whether the current user is the authorized user. The data provider is configured to give the current user access to a set of fake data instead of the set of private data if the current user is not the authorized user.

Another embodiment provides a method to be performed by an electronic device. The method includes the following steps: covertly collecting a set of biometric samples from a current user of the electronic device; covertly using the set of biometric samples of the current user and a set of biometric data of an authorized user to verify whether the current user is the authorized user; and giving the current user access to a set of fake data instead of a set of private data of the authorized user if the current user is not the authorized user.

Another embodiment provides a machine readable storage medium storing executable program instructions. When executed, the program instructions cause an electronic device to perform a method including the following steps: covertly collecting a set of biometric samples from a current user of the electronic device; covertly using the set of biometric samples of the current user and a set of biometric data of an authorized user to verify whether the current user is the authorized user; and giving the current user access to a set of fake data instead of a set of private data of the authorized user if the current user is not the authorized user.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a simplified block diagram of an electronic device according to an embodiment of the invention.

FIG. 2 shows a simplified block diagram of the biometric authenticator of FIG. 1 according to an embodiment of the invention.

FIG. 3 illustrates how the electronic device of FIG. 1 may create a user-specific model for an authorized user covertly.

FIG. 4 illustrates how the electronic device of FIG. 1 may create a speaker-dependent model based on a set of voice samples of an authorized user and a speaker-independent model.

FIG. 5 illustrates how the electronic device of FIG. 1 may use a set of voice samples of an unidentified user and a speaker-dependent model to verify whether the unidentified user is the same as an authorized user.

FIG. 6 illustrates how the electronic device of FIG. 1 may use a set of voice samples of an unidentified user and several speaker-dependent models to verify whether the unidentified user is the same as an authorized user.

FIG. 7 shows a simplified flowchart of a method the electronic device of FIG. 1 performs.

FIG. 8 and FIG. 9 show examples of the electronic device of FIG. 1 displaying either a set of private date or a set of fake data.

### DETAILED DESCRIPTION

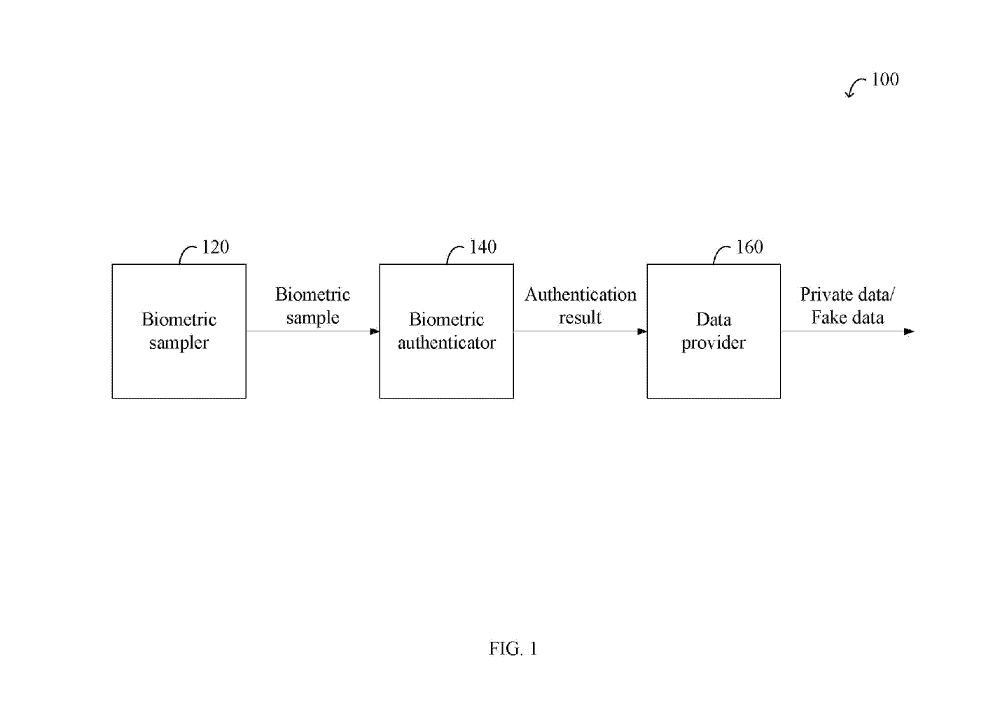

FIG. 1 shows a simplified block diagram of an electronic device according to an embodiment of the invention. To name a few examples, the electronic device 100 may be a consumer electronic device, such as a smart phone, a laptop computer, a tablet computer, or a smart television.

In addition to other components not depicted in FIG. 1, the electronic device 100 further includes a biometric sampler 120, a biometric authenticator 140, and a data provider 160. The biometric sampler 120 may collect a set of biometric samples from a person who is using the electronic device 100. The person may be either an authorized user or an unidentified user of the electronic device 100. For example, the set of biometric samples may include any of the followings: image files of the person's face, iris, fingerprint, and hand geometry, and voice files of the person's utterances. To collect the set of biometric samples from the person, the biometric sampler 120 may include any of the followings: a camera, a scanner, and a microphone. For example, if the electronic device 100 has a touch screen, the touch screen may be able to serve as the scanner and scan the person's fingerprint or hand geometry.

The biometric authenticator 140 has access to a set of biometric data that is specific to an authorized user of the electronic device 100. For example, the set of biometric data may include a user model specific to the authorized user, and the user-specific model may be stored on the electronic device 100 or a cloud storage device. With a set of biometric samples the biometric sampler 120 collects from an unidentified user and the set of biometric data of the authorized user, the biometric authenticator 140 may identify the unidentified user by verifying whether he/she is the authorized user.

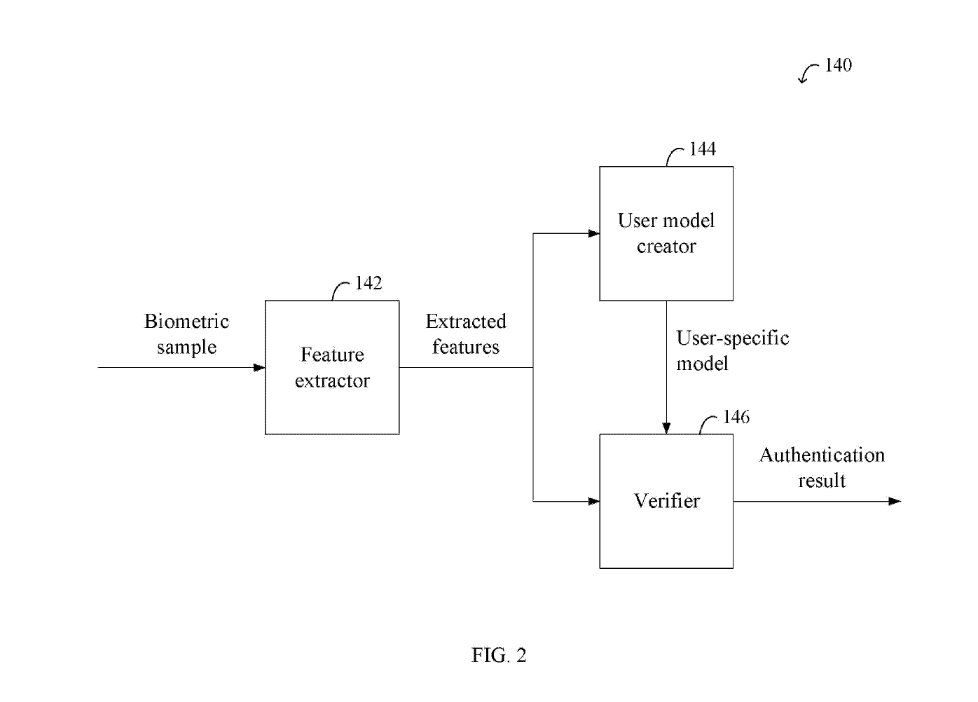

FIG. 2 shows a simplified block diagram of the biometric authenticator 140 of FIG. 1 according to an embodiment of the invention. The biometric authenticator 140 of this embodiment includes a feature extractor 142, a user model creator 144, and a verifier 146. If there is another electronic device that can create the set of biometric data of the authorized user and then share the set of data with the electronic device 100, the user model creator 144 may be omitted from FIG. 2.

The feature extractor 142 extracts features from a set of biometric samples the biometric sampler 120 collects from the person who is using the electronic device 100. The features may be unique to that person and be different from features extracted from biometric samples of another person. For example, if the set of biometric samples contains a voice sample, the feature extractor 142 may extract any of the following features from the voice sample: spectral features such as Mel-Frequency Cepstral Coefficients (MFCC), Perceptual Linear Prediction (PLP), Line Spectral Pairs (LSP), and Linear Prediction Cepstral Coefficients (LPCC); prosodic features such as pitch, delta-pitch, formant, and vocal tract related features; spectro-temporal feature such as Gabor features, RelAtive SpecTrA (RASTA), TempoRAl Pattern (TRAP), and speaking rate; other features such as Signal-to-Noise Ratio (SNR).

If the feature extractor 142 extracts the features from biometric samples of the authorized user of the electronic device 100, the feature extractor 142 may pass the features to the user model creator 144. Based on the features, the user model creator 144 may create a user-specific model for the authorized user. As mentioned, the user-specific model may constitute the set of biometric data of the authorized user. For example, the user-specific model may be created based upon any of the following theories: Hidden Markov Model (HMM), Gaussian Mixture Model (GMM), Support Vector Machine (SVM), Multi-Layer Perception (MLP), Single-Layer Perception (SLP), Decision Tree (DT), and Random Forest (RF).

When collecting the set of biometric samples from the authorized user, the electronic device 100 may let the authorized user aware/know the biometric samples collection. Alternatively, the electronic device 100 may collect the set of biometric samples covertly. Throughout this application, whenever the adverb “covertly” is used to modify an act performed by a device/component, it means that the device/component performs the act without requesting permission from its user in advance, nor does the device/component let its user know that it's doing so. In other words, the device/component may perform in the background and it's very likely that the user will be unaware of the performance of the act. For example, even if the user is not an authorized one, the device/component still collects the biometric samples without rejecting or awaking the user (probably let the user access a set of fake data).

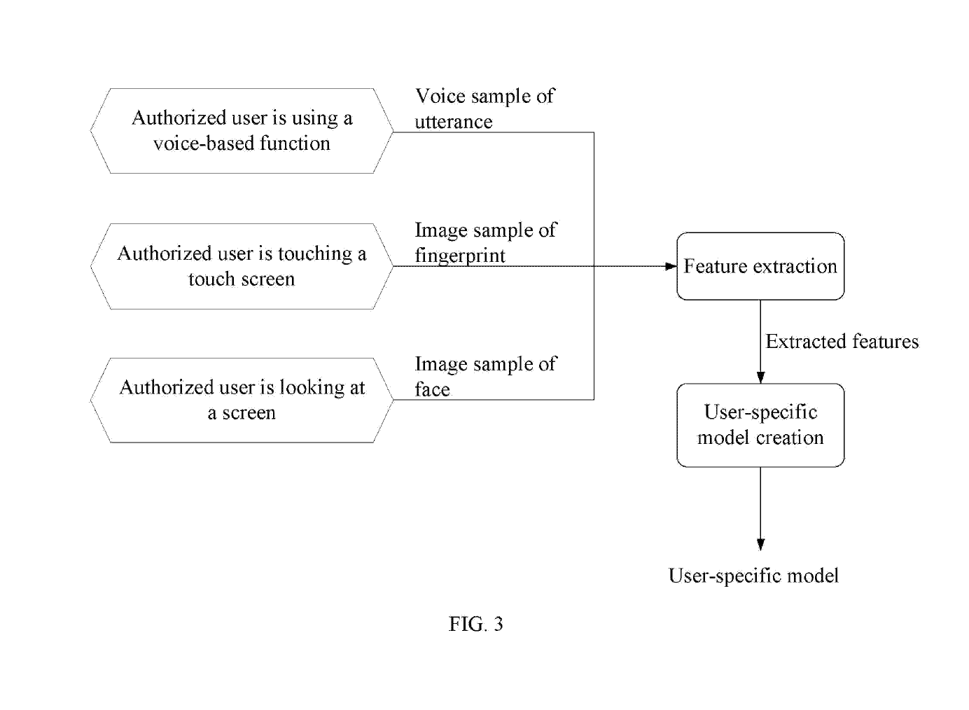

FIG. 3 illustrates how the electronic device 100 may create the user-specific model for the authorized user covertly. The biometric sampler 120 may do any of the followings covertly to collect a set of biometric samples when the authorized user is using the electronic device 100: use a microphone to record a voice sample of the user's utterance when the user is using a voice-based function of the electronic device 100; use a touch screen to scan an image sample of the user's fingerprint when the user is touching the touch screen; use a camera to capture an image sample of the user's face when the user is looking at a screen of the electronic device 100. For example, the voice-based function may be a language learning function, a voice searching function, a voice memo function, a Voice-over-Internet Protocol (VoIP) function, a voice command function, or a telephone/mobile phone function. The voice-based function may be facilitated by a piece of application software (APP). To be more specific, the aforementioned voice memo function may allow the user to create or retrieve memo items using voice commands. For example, the user may utter the word “Tuesday” to retrieve all the memo items related to Tuesday, such as plans for Tuesday. With the set of biometric samples of the authorized user, the feature extractor 142 may then extract features therefrom and the user model creator 144 may create the user-specific model based on the extracted features.

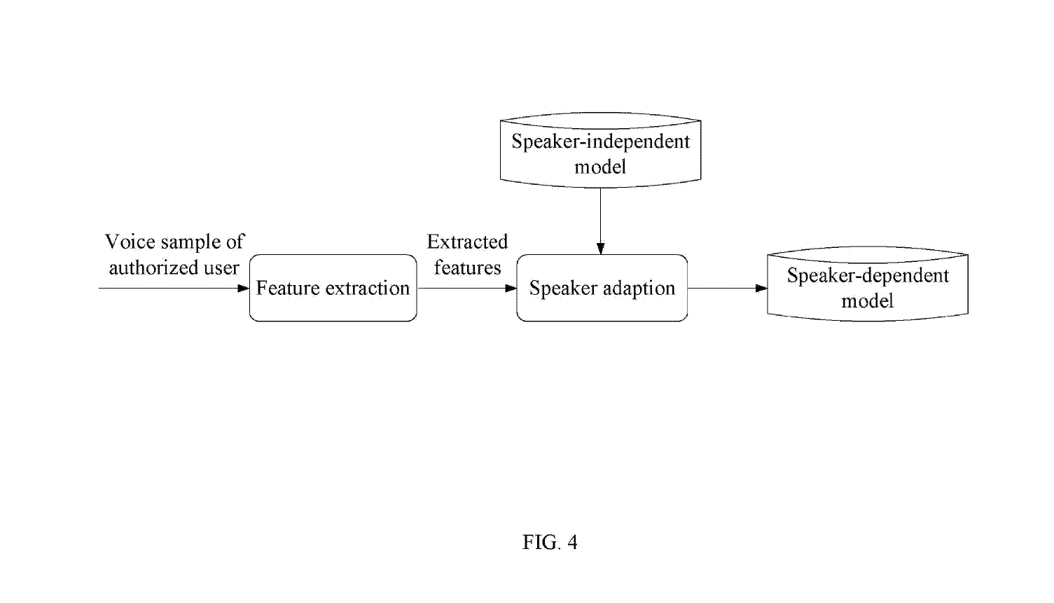

FIG. 4 illustrates how the electronic device 100 may create a speaker-dependent model, which is a kind of user-specific model, based on a set of voice samples of the authorized user and a speaker-independent model. For example, the speaker-independent model may be a Speaker-Independent Hidden Markov Model (SI-HMM) that has been pre-trained by a large number of speakers. First, the biometric sampler 120 may use a microphone to record a voice sample of the authorized user's utterance when he/she is using a voice-based function of the electronic device 100. Then, the feature extractor 142 may extract features from the voice sample. Next, the user model creator 144 may use the extracted features to train/adapt the speaker-independent model to generate the speaker-dependent model. For example, the speaker dependent model may be a Speaker-Dependent Hidden Markov Model (SD-HMM).

If the feature extractor 142 extracts the features from a set of biometric samples of an unidentified user of the electronic device 100, the feature extractor 142 may pass the features to the verifier 146. The verifier 146 may use the user-specific model of the authorized user and the set of biometric samples of the unidentified user to determine the identity the unidentified user, i.e. to verify whether the unidentified user and the authorized user are the same person.

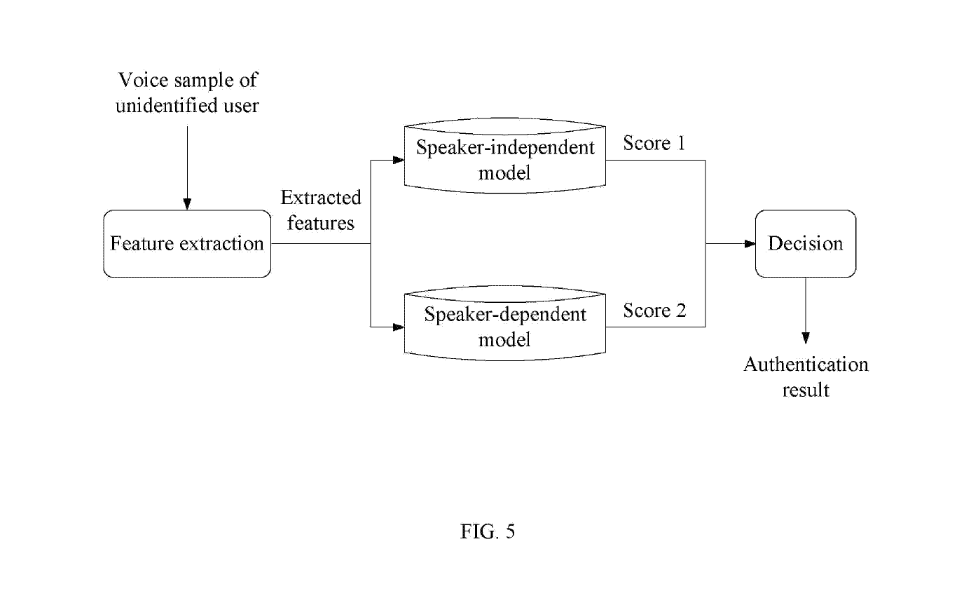

FIG. 5 illustrates how the electronic device 100 may use a set of voice samples of an unidentified user and the speaker-dependent model to verify whether the unidentified user is the same as the authorized user. First, the biometric sampler 120 may use a microphone to record a voice sample of the unidentified user's utterance when he/she is using a voice-based function of the electronic device 100. Then, the feature extractor 142 may extract features from the voice sample. Next, the verifier 146 may generate a score 1 to indicate to what extent the extracted features matches the speak-independent model and a score 2 to indicate to what extent the extracted features matches the speak-dependent model. Specifically, score 1 may imply whether the unidentified user is like an average speaker, and score 2 may imply whether the unidentified user is like the authorized user. Then, the verifier 146 may examine the two scores to determine whether the unidentified user is the authorized user, i.e. whether the unidentified user passes or fails the authentication test. For example, if score 2 is larger than score 1 plus a margin, the verifier 146 may determine that the unidentified user is the authorized one and let him/her pass the test. Otherwise, the verifier 146 may determine that the unidentified user is not the authorized one and let him/her fail the test.

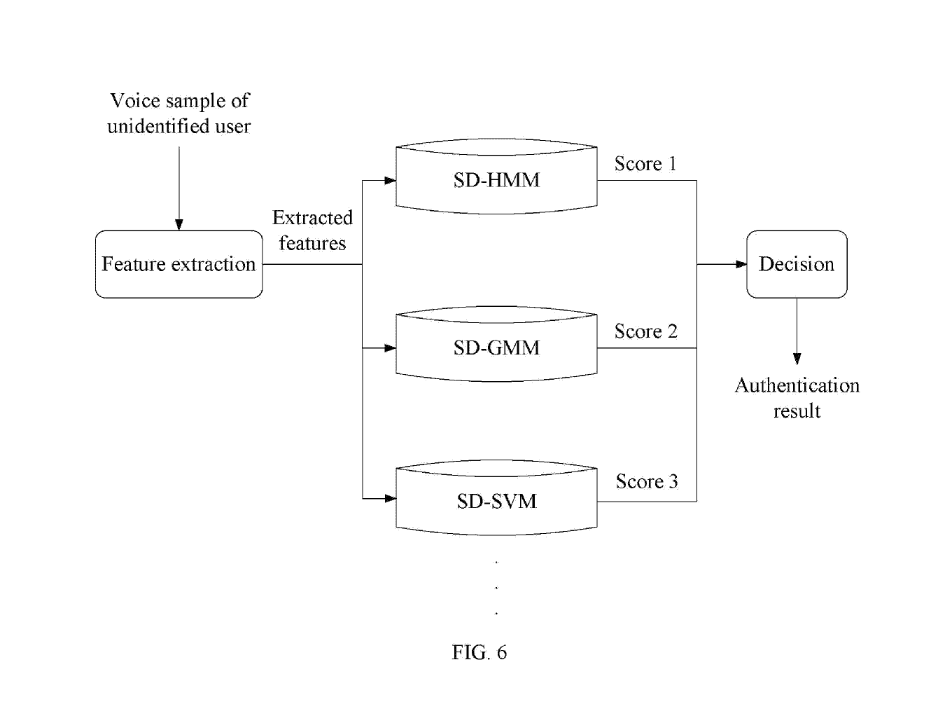

FIG. 6 illustrates how the electronic device 100 may use a set of voice samples of an unidentified user and several speaker-dependent models to verify whether the unidentified user is the same as the authorized user. In this example, the speaker-dependent models include a Speaker-Dependent Hidden Markov Model (SD-HMM), a Speaker-Dependent Gaussian Mixture Model (SD-GMM), and a Speaker-Dependent Support Vector Machine (SD-SVM). These models are specific to the authorized user. To verify whether the unidentified user is the authorized one, the biometric sampler 120 may first use a microphone to record a voice sample of the unidentified user's utterance when he/she is using a voice-based function of the electronic device 100. Then, the feature extractor 142 may extract features from the voice sample. Next, the verifier 146 may generate a score 1, a score 2, and a score to indicate to what extent the extracted features matches the SD-HMM, the SD-GMM, and the SD-SVM, respectively. Then, the verifier 146 may examine the scores to determine whether the unidentified user is the authorized one, i.e. whether the unidentified user passes or fails the authentication test.

The data provider 160 of FIG. 1 may have access to a set of private data that should be protected from unauthorized access by anyone other than the authorized user. The set of private data may be stored on the electronic device 100 or a cloud storage device. With the authentication result provided by the biometric authenticator 140, the data provider 160 may decide whether to give a current user of the electronic device 100 access to the set of private data or a set of fake data instead.

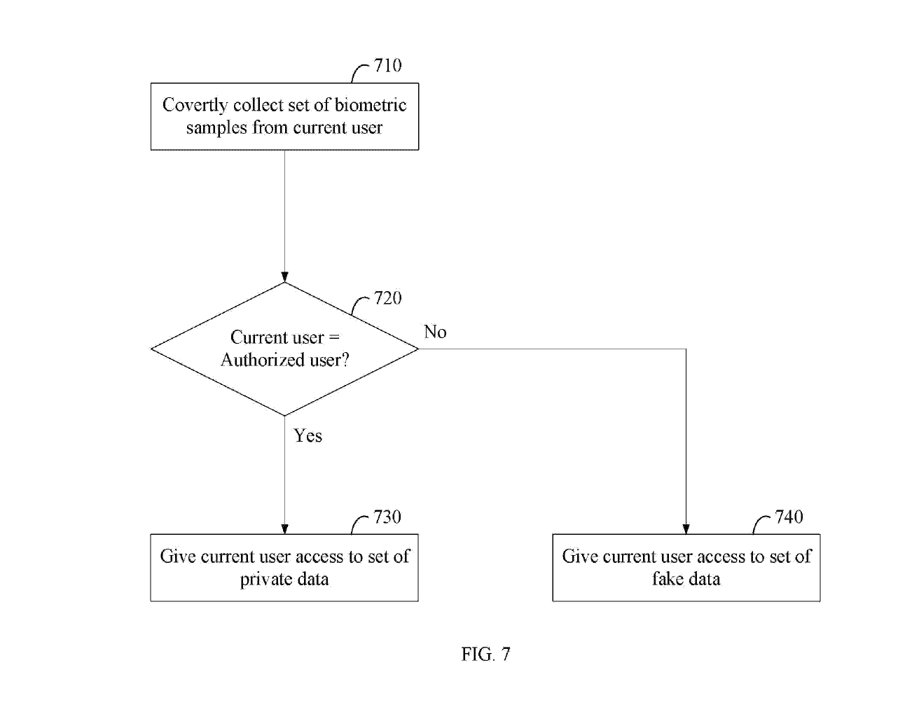

FIG. 7 shows a simplified flowchart of a method the electronic device 100 of FIG. 1 performs. At step 710, the electronic device 100 uses the biometric sampler 120 to covertly collect the set of biometric samples from the electronic device 100's current user. At this step, the electronic device 100 may be uncertain as to whether the current user is the authorized one, hence the current user may also be referred to as an unidentified user.

In performing step 710, the electronic device 100 does not inform the current user that it is doing so, nor does it request for permission in advance. In other words, the electronic device 100 may perform step 710 in the background. Without being reminded of this step, the current user may not be alerted to the existence of the authentication system. For example, at step 710, the electronic device 100 may do any of the followings: take a photo when the current user's face happens to be in front of a camera of the electronic device 100; scan the current user's fingerprint/hand geometry when the current user's finger/palm happens to be touching a scanner of the electronic device 100; record the current user's utterance when the current user happens to be speaking near a microphone of the electronic device 100.

It's possible for the electronic device 100 to perform step 710 without letting the current user know that it's doing so. In fact, when holding or using the electronic device 100, the current user may not know that he/she is giving the biometric sampler 120 many opportunities to covertly collect the set of biometric samples. As a first example, the current user's face may often be in front of the electronic device 100's camera in order to see a screen of the device 100. Therefore, the camera may have some chances to covertly take a photo of the current user for face-based authentication. As a second example, the current user's finger may be touching the electronic device 100's touch screen when operating the device 100. Therefore, the touch screen may have some chances to covertly scan a fingerprint of the current user for fingerprint-based authentication. As a third example, the current user may be speaking near the electronic device 100's microphone when using a voice-based function. Therefore, the microphone may have some chances to covertly record the current user's utterance for voice-based authentication.

Then, at step 720, the biometric authenticator 140 covertly uses the set of biometric samples of the current user and the set of biometric data of the authorized user to verify whether the current user and the authorized user are the same person. If the biometric authenticator 140 verifies that the current user is the authorized one, the electronic device 100 enters step 730. Otherwise, the electronic device 100 enters step 740 because the current user may be a hacker or an imposter. The electronic device 100 needs not to let the current user know the authentication result nor the existence of step 720. In other words, the electronic device 100 may perform step 720 in the background.

At step 730, the data provider 160 give the current user access to the set of private data, e.g. by displaying on a screen whatever the current user asks for. For example, if the set of private data includes a schedule, a phone book, and a message folder of the authorized user, the data provider 160 may allow the current user to see the schedule, use the phone book, or read messages in the message folder freely at step 730.

At step 740, the data provider 160 gives the current user access to a set of fake data instead of the set of private data. This set of data may be fake for any of the following reasons: it contains only insensitive data but lacks sensitive data; it contains sensitive data but incompletely; it contains some fabricated data that's not real. The set of fake data may need to seem as real as possible to prevent the current user from being alerted. As long as the set of fake data misleads the current user to believe that he/she is accessing real data, the current user may be unaware that his/her unauthorized conduct has been detected. As a result, the current user may keep using the electronic device 100 boldly.

Step 740 may buy the electronic device 100 some time to take responsive measures against the unauthorized use. As an example, the electronic device 100 may covertly send out the current user's photo, fingerprint, hand geometry, or voice so that the authorized user or the law enforcement may try to figure out who has stolen the electronic device 100. As another example, the electronic device 100 may covertly reveal its current location so that the authorized user or the law enforcement may know where to retrieve this stolen device or even arrest the current user. As an extreme example, if the set of private data is highly confidential, the electronic device 100 may even delete the set of private data or destroy itself.

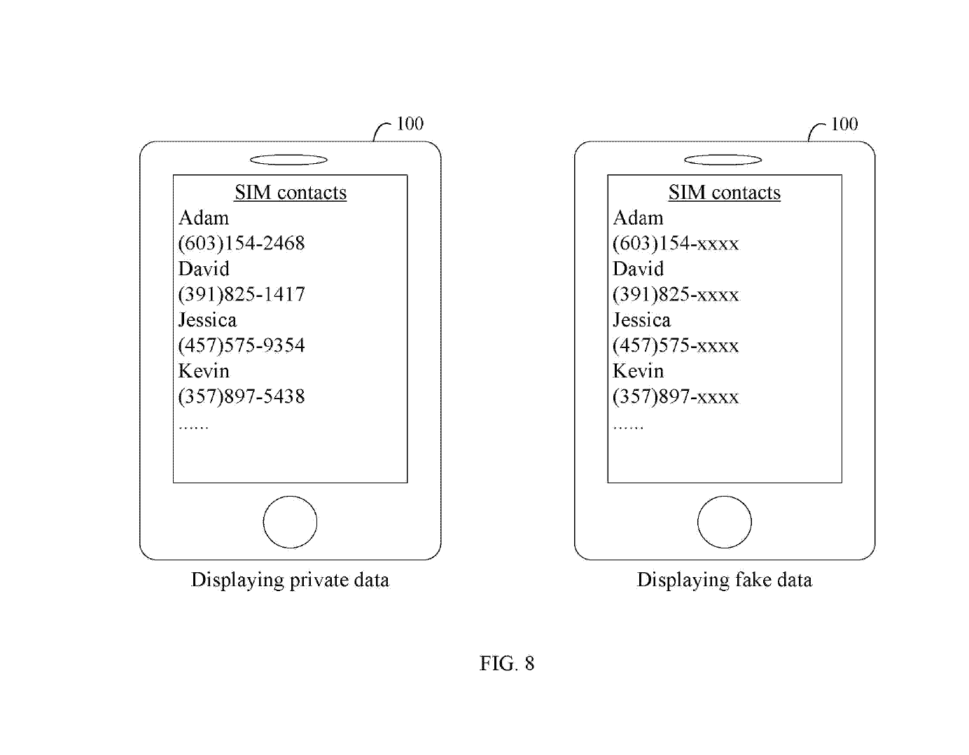

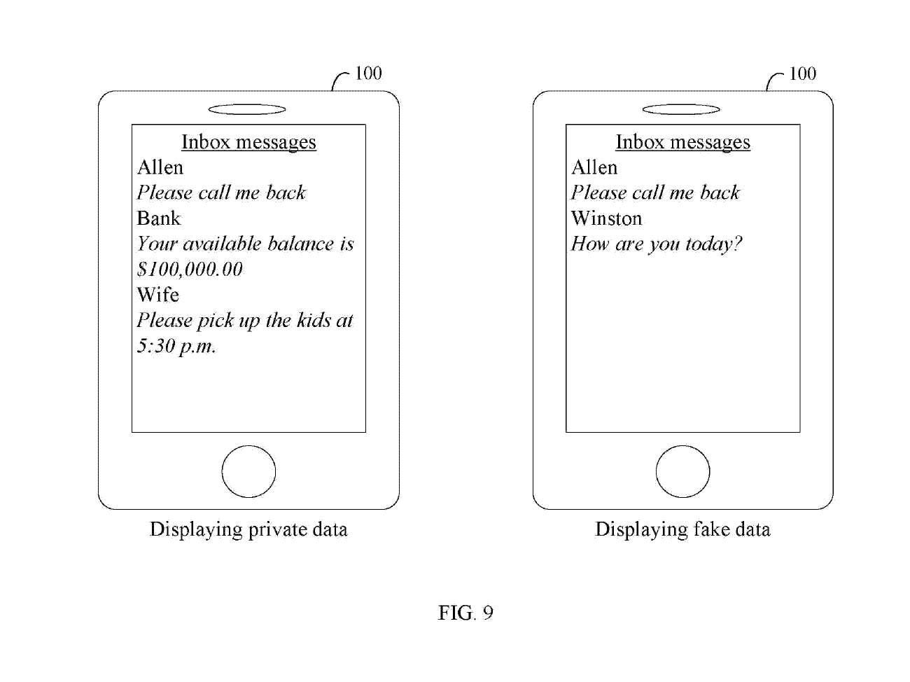

To make the set of fake data seem as real as possible, the data provider 160 may fabricate the set of fake data based on the set of private data so that at least a part of the set of private data is also included in the set of fake data. For example, if the current user tries to access a piece of the private data, the data provider 160 may create a piece of fake data by hiding some or all of the characters in the piece of private data, and then show the piece of fake data to the current user. Because it may seem normal for the electronic device 100 to do so even to the authorized user, this may not alert the current user unequivocally. As another example, if the current user tries to access a message folder, the data provider 160 may hide important messages and show only insensitive messages or fabricated messages to the current user. FIG. 8 and FIG. 9 show examples of the electronic device 100 displaying either a set of private date or a set of fake data. In FIG. 8, the set of private data include a plurality of phone numbers of a plurality of contacts; the set of fake data is similar to the set of private data, but some of the characters in the phone numbers are hidden. In FIG. 9, the set of private data include a plurality of received messages; the set of fake data is similar to the set of private data, but some of the real messages are hidden and one fabricated message is included.

Any of the aforementioned methods may be codified into program instructions. The program instructions may be stored in a machine readable storage medium, such as an optical disc, a hard disk drive, a solid-state drive, or a memory device of any kind. When executed by the electronic device 100, the program instructions may cause the electronic device 100 to perform the codified method.

As mentioned above, the electronic device 100 verifies the current user's identity without letting him/her know that it's doing so. Furthermore, the electronic device 100 provides the current user with the set of fake data if he/she is not the authorized user. All these may avoid alerting the current user to the existence of the authentication system. Without alerting the current user to the existence of the authentication system, the electronic device 100 may better protect the set of private date and gain more time to tackle unauthorized use by the current user.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

1. A method performed by an electronic device to protect a set of private data of an authorized user of the electronic device, the electronic device comprising a biometric sample, a biometric authenticator and a data provider, the method comprising:
utilizing the biometric sampler to covertly collect a set of biometric samples from a current user of the electronic device;
utilizing the biometric authenticator to covertly use the set of biometric samples of the current user and a set of biometric data of the authorized user to verify whether the current user is the authorized user; and
utilizing the data provider to give the current user access to a set of fake data instead of the set of private data when the current user is determined to be different from the authorized user.

2. The method of claim 1, wherein the step of covertly collecting the set of biometric samples from the current user comprises:
collecting the set of biometric samples from the current user without letting the current user aware of the step of biometric samples collection.

3. The method of claim 1, wherein the step of covertly collecting the set of biometric samples from the current user comprises:
covertly collecting a fingerprint from the current user when the current user's finger is touching a touch screen of the electronic device.

4. The method of claim 1, wherein the step of covertly collecting the set of biometric samples from the current user comprises:
covertly recording an utterance of the current user when the current user is speaking.

5. The method of claim 1, wherein the step of covertly collecting the set of biometric samples from the current user comprises:
covertly taking a photo of the current user when the current user is facing a camera of the electronic device.

6. The method of claim 1, further comprising:
fabricating the set of fake data based on the set of private data, so that at least a part of the set of private data is also included in the set of fake data.

7. The method of claim 1, wherein the set of fake data comprises at least a piece of fabricated data that is not a part of the set of private data.

8. An electronic device configured to protect a set of private data of an authorized user of the electronic device, the electronic device comprising:
a biometric sampler, configured to covertly collect a set of biometric samples from a current user of the electronic device;
a biometric authenticator, coupled to the biometric sampler, configured to covertly use the set of biometric samples of the current user and a set of biometric data of the authorized user to verify whether the current user is the authorized user; and
a data provider, coupled to the biometric authenticator, configured to give the current user access to a set of fake data instead of the set of private data when the biometric authenticator determines that the current user is different from the authorized user.

9. The electronic device of claim 8, wherein the biometric sampler comprises a touch screen configured to covertly scan a fingerprint of the current user.

10. The electronic device of claim 8, wherein the biometric sampler comprises a camera configured to covertly take a photo of the current user.

11. The electronic device of claim 8, wherein the biometric sampler comprises a microphone configured to covertly record an utterance of the current user.

12. The electronic device of claim 8, wherein the data provider is configured to fabricate the set of fake data based on the set of private data, so that at least a part of the set of private data is also included in the set of fake data.

13. The electronic device of claim 8, wherein the data provider is configured to include a piece of fabricated data in the set of fake data, and the piece of fabricated data is not a part of the set of private data.

14. A machine readable storage medium storing executable program instructions which when executed cause an electronic device to perform a method, wherein the electronic device comprises a biometric sampler, a biometric authenticator and a data provider, and the method comprises:
utilizing the biometric sampler to covertly collect a set of biometric samples from a current user of the electronic device;
utilizing the biometric authenticator to covertly use the set of biometric samples of the current user and a set of biometric data of an authorized user to verify whether the current user is the authorized user; and
utilizing the data provider to give the current user access to a set of fake data instead of a set of private data if when the current user is determined to be different from the authorized user.

15. The machine readable storage medium of claim 14, wherein the step of covertly collecting the set of biometric samples from the current user comprises:
collecting the set of biometric samples from the current user without letting the current user know that the electronic device is doing so.

16. The machine readable storage medium of claim 14, wherein the step of covertly collecting the set of biometric samples from the current user comprises:
covertly collecting a fingerprint from the current user when the current user's finger is touching a touch screen of the electronic device.

17. The machine readable storage medium of claim 14, wherein the step of covertly collecting the set of biometric samples from the current user comprises:
covertly recording an utterance of the current user when the current user is speaking.

18. The machine readable storage medium of claim 14, wherein the step of covertly collecting the set of biometric samples from the current user comprises:
covertly taking a photo of the current user when the current user is facing a camera of the electronic device.

19. The machine readable storage medium of claim 14, wherein the method further comprises:
fabricating the set of fake data based on the set of private data, so that at least a part of the set of private data is also included in the set of fake data.

20. The machine readable storage medium of claim 14, wherein the set of fake data comprises at least a piece of fabricated data that is not a part of the set of private data.
